(19) United States
(12) Patent Application Publication
(10) Pub. No.: US 2018/0163085 A1
(43) Pub. Date: Jun. 14, 2018

(54) Surface Coating Agent for Tires

(71) Applicant: The Yokohama Rubber Co., LTD., Minato-ku, Tokyo (JP)

(72) Inventors: Shinya Takeda, Hiratsuka-shi, Kanagawa (JP); Rieko Wakamatsu, Sumida-ku, Tokyo (JP); Hideo Amano, Sumida-ku, Tokyo (JP)

(21) Appl. No.: 15/579,160

(22) PCT Filed: Jun. 2, 2016
(86) PCT No.: PCT/JP2016/066447

§ 371 Date: Dec. 1, 2017

(30) Foreign Application Priority Data
Jun. 5, 2015 (JP) 2015-114605

(51) Int. Cl. C09D 171/02; B29D 30/00

(52) U.S. Cl. CPC C09D 171/02; B29D 30/0005

(57) ABSTRACT

A tire surface coating agent which is coated on the surface of an unvulcanized tire or a vulcanized pneumatic tire includes 2 to 100 wt. % of a specific polyalkylene glycol carboxylic acid alkyl ester.

### TECHNICAL FIELD

The present technology relates to a tire surface coating agent that advances tire appearance to or beyond conventional levels while ensuring excellent ozone resistance.

### BACKGROUND ART

Heretofore, it has been known that rubber compositions which blend natural rubber and conjugated diene based rubber are subjected to oxidative deterioration in the presence of ozone, generating cracks (ozone cracks) on the surface and reducing physical properties. In particular, ozone deterioration on the sidewall portions of pneumatic tires is highly problematic.

In order to prevent oxidative deterioration caused by ozone, a wax and an amine based anti-aging agent are blended in a rubber composition forming the sidewall portion. As a result, the generation and progression of ozone cracks can be suppressed. Unfortunately, when the wax migrates to the surface of the sidewall portion and crystallizes, it leads to poor appearance such as whitening, while when the amine based anti-aging agent migrates to the surface, it generates defects such as browning, problematically deteriorating tire appearance in both cases.

In regards to this, Japanese Unexamined Patent Application Publication No. 2013-249450 proposes that by coating a specific nonionic surfactant on the surface of an unvulcanized tire, browning and whitening of tire outer skin rubbers are suppressed. However, as the demand by consumers in terms of the appearance of pneumatic tires has progressively increased in recent years, the demand for obtaining more excellent tire appearance without whitening or browning while ensuring ozone resistance has further been requested.

Moreover, generally, during the use of product tires, a tire polishing wax is preferably coated to maintain a favorable appearance. Japanese Unexamined Patent Application Publication Nos. 07-242857 and 2005-171041, for example, propose that polish, blackness, and gloss be imparted to tires to sustain these effects. Unfortunately, whitening derived from wax blooming on the tire surface, as well as browning derived from amine based anti-aging agents, has not been suppressed.

### SUMMARY

The present technology provides a tire surface coating agent that improves tire appearance to or beyond conventional levels while ensuring excellent ozone resistance.

The tire surface coating agent according to the present is coated on the surface of an unvulcanized tire or a vulcanized pneumatic tire and includes 2 to 100 wt. % of polyalkylene glycol carboxylic acid alkyl ester represented by the following general formula (I):

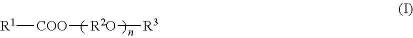

(where R¹ represents a hydrocarbon group having 5 to 19 carbons, R² represents an ethylene group or a propylene group, R³ represents a methyl group or an ethyl group, and n is an integer of from 1 to 8.)

Regarding the tire surface coating agent according to the present technology, a paraffin wax and an amine based anti-aging agent are blended in a tire rubber composition in order to obtain excellent ozone resistance and the specific polyalkylene glycol carboxylic acid alkyl ester is coated on the tire surface, thereby suppressing whitening derived from the wax blooming on the tire surface as well as browning derived from the amine based anti-aging agent, allowing excellent tire appearance to be obtained.

When R¹ described in the general formula (I) is a hydrocarbon group having 9 to 19 carbons and n is an integer of from 1 to 5, whitening can be more effectively suppressed. Further, when R² is an ethylene group, excellent liquid stability and handleability upon achieving a composition as a water based coating agent can be obtained, along with a more excellent effect of suppressing whitening and browning.

In the method for manufacturing a pneumatic tire according to the present technology, the abovementioned tire surface coating agent is coated on the surface of an unvulcanized tire, then vulcanized and molded, thereby suppressing wax blooming on the tire surface from solidifying and whitening, so as to obtain excellent tire appearance.

Regarding the use of the tire surface coating agent according to the present technology, the tire surface coating agent may be coated on the surface of a vulcanized pneumatic tire, and as required, heated at 30 to 60° C. for 2 hours or longer. By applying the wax cured on the tire surface onto the surface coating agent and softened it, a more excellent effect of suppressing whitening on the tire surface can be obtained.

### DETAILED DESCRIPTION

Regarding a tire rubber composition making up an unvulcanized rubber and a vulcanized pneumatic tire, the rubber component thereof is made up of diene based rubber. Examples of diene based rubber include natural rubber, isoprene rubber, butadiene rubber, styrene-butadiene rubber, acrylonitrile butadiene rubber, butyl rubber, halogenated butyl rubber, ethylene-propylene-diene rubber, chloroprene rubber, etc. Of these, natural rubber, butadiene rubber, styrene-butadiene rubber, ethylene-propylene-diene rubber, and halogenated butyl rubber are preferable, with natural rubber and butadiene rubber particularly preferable, and the rubber composition may contain these as the main components. Containing natural rubber and butadiene rubber as the main components means that the rubber composition contains no less than a total of 50 wt. % of natural rubber and butadiene rubber per 100 wt. % of the diene based rubber. The total natural rubber and butadiene rubber is more preferably from 50 to 100 wt. % and even more preferably from 65 to 100 wt. %. By having natural rubber and butadiene rubber as the main components of the diene based rubber, excellent ozone resistance and flexural fatigue resistance of the tire rubber composition can be obtained.

In the present technology, the content of the natural rubber is from 20 to 80 wt. %, preferably from 25 to 70 wt. %, and more preferably from 30 to 65 wt. %, per 100 wt. % of diene based rubber. The content of the butadiene rubber is from 10 to 80 wt. %, preferably from 15 to 75 wt. %, and more preferably from 35 to 70 wt. %, per 100 wt. % of diene based rubber.

By blending paraffin wax in the tire rubber composition, the generation and progression of ozone cracks can be suppressed. While not particularly limited, the paraffin wax is preferably an aliphatic saturated hydrocarbon having from 15 to 55 carbons, more preferably a linear aliphatic saturated hydrocarbon having from 23 to 45 carbons, even more preferably having from 25 to 45 carbons. Note that it may partially include a branched aliphatic saturated hydrocarbon.

The blending amount of the paraffin wax is preferably from 0.5 to 10 parts by weight and more preferably from 1.0 to 6.0 parts by weight, per 100 parts by weight of the diene based rubber. If the blending amount of the paraffin wax is less than 0.5 parts by weight, the generation and progression of ozone cracks cannot be sufficiently suppressed. Moreover, if the blending amount of the paraffin wax exceeds 10 parts by weight, the deposition and crystallization of the rubber composition on the surface become significant and whitening derived from the paraffin wax cannot be suppressed.

By blending the amine based anti-aging agent in the tire rubber composition, the generation and progression of ozone cracks particularly upon dynamic use can be suppressed. Examples of the amine based anti-aging agent include alkylated diphenylamine, 4,4′-bis(α,α-dimethyl benzyl)diphenylamine, N,N′-diphenyl-p-phenylenediamine, N-phenyl-N′-isopropyl-p-phenylenediamine, N-phenyl-N′-1,3-dimethyl butyl-p-phenylenediamine, p-(p-toluene sulfonylamide)diphenylamine, N-phenyl-N-(3-methachroyloxy-2-hydroxypropyl)-p-phenylenediamine, etc., with N-phenyl-N′-1,3-dimethyl butyl-p-phenylenediamine being particularly preferable among these.

The blending amount of the amine based anti-aging agent is preferably from 0.5 to 10 parts by weight and more preferably from 1.0 to 5.0 parts by weight, per 100 parts by weight of the diene based rubber. If the blending amount of the amine based anti-aging agent is less than 0.5 parts by weight, the generation and progression of ozone cracks in tires which have started to be used cannot be sufficiently suppressed. Moreover, if the blending amount of the amine based anti-aging agent exceeds 10 parts by weight, blooming of the rubber composition on the surface becomes significant and browning of the surface appearance cannot be suppressed.

Examples of the tire surface coating agent according to the present technology may include: a mold release agent, which is coated on the surface of an unvulcanized tire to enhance workability; a polishing wax, a polishing agent, and a tire coating, which are coated on a vulcanized pneumatic tire to improve appearance; etc. These tire surface coating agents may be either hydrophilic or hydrophobic. From the perspective of decreasing the load on the global environment, it may be a water based mold release agent, a water based polishing wax, or a water based outside tire paint.

If the tire surface coating agent according to the present technology contains a specific polyalkylene glycol carboxylic acid alkyl ester, the whitening and browning of tire appearance can be suppressed. Moreover, hydrophilicity and hydrophobicity of the tire surface coating agent are appropriately balanced with molecular weights close to waxes. Therefore, when mixed with a paraffin wax blooming on the tire surface, it is compatible with the paraffin wax. Therefore, paraffin wax migrating to the surface of the rubber composition is suppressed from being cured (crystallized), with flexibility imparted to the paraffin wax. Accordingly, when the rubber surface is rubbed, crystals of the paraffin wax are finely split, allowing the generation of diffused reflection of light and the resultant whitening to be reduced as much as possible. Moreover, the protection action of the paraffin wax is maintained so as to ensure ozone resistance. Further, because the amine based anti-aging agent, which has appropriate hydrophobicity and therefore high hydrophilicity, can be suppressed from migrating to the outermost surface, the surface appearance can be prevented from browning.

In the tire surface coating agent according to the present technology, the polyalkylene glycol carboxylic acid alkyl ester is represented by the following general formula (I).

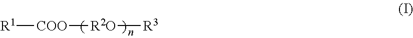

(where R¹ represents a hydrocarbon group having from 5 to 19 carbons, R² represents an ethylene group or a propylene group, R³ represents a methyl group or an ethyl group, and n is an integer of from 1 to 8.)

R¹ is a hydrocarbon group having from 5 to 19 carbons, and may be either a saturated hydrocarbon group or an unsaturated hydrocarbon group. R¹ is preferably a saturated or unsaturated hydrocarbon group having from 9 to 19 carbons. When R¹ has 5 carbons or more, preferably 9 carbons or more, transpiration tends not to occur upon coating on the tire surface. Moreover, when it has 19 carbons or less, liquid stability as a tire surface coating agent is excellent and wax derived whitening can be suppressed.

Specific examples of the fatty acid corresponding to the fatty acid portion (R¹CO portion) in the general formula (I) include caproic acid, caprylic acid, capric acid, lauric acid, myristic acid, myristoleic acid, palmitic acid, palmitoleic acid, stearic acid, oleic acid, linoleic acid, linolenic acid, palm derived C18 mixed fatty acid, rapeseed derived C18 mixed fatty acid, coconut derived C8 to C14 mixed fatty acid, palm kernel derived C8 to C18 mixed fatty acid, arachidic acid, etc.

R²O is an oxyethylene group (—CH₂CH₂O—) or an oxypropylene group (—CH(—CH₃)CH₂O—). R²O may have both an oxyethylene group and an oxypropylene group. R²O is more preferably an oxyethylene group from the perspective of suppressing the whitening of tire appearance, and further from the perspective of liquid stability as the water based coating agent.

R³ is a methyl group or an ethyl group.

n is an addition molar number of oxyalkylene groups (R²O) and an integer of from 1 to 8. When R²O is an oxyethylene group and n exceeds 8, the polyalkylene glycol carboxylic acid alkyl ester has strong hydrophilicity and is not compatible with waxes, preventing whitening from being suppressed. Moreover, browning derived from the anti-aging agent occurs. Further, because it is soluble in water, it may be washed away by water such as rain. When R²O is an oxypropylene group and n exceeds 8, for reasons unknown, whitening cannot be suppressed. When n is less than 1, the hydrophobicity of the polyalkylene glycol carboxylic acid alkyl ester strengthens and the effect of suppressing the paraffin wax from being cured (crystallized) is not obtained. Therefore, whitening derived from the paraffin wax cannot be suppressed. Therefore, from the perspective of having an appropriate balance between hydrophobicity and hydrophilicity and suppressing whitening, n is an integer of from 1 to 8, and preferably is an integer of from 1 to 5. By appropriately adjusting the balance between the hydrophobicity and hydrophilicity of the polyalkylene glycol carboxylic acid alkyl ester used in the present technology, the polyalkylene glycol carboxylic acid alkyl ester acts on the paraffin wax, that is, is compatible with the paraffin wax, whereby it is suppressed from being crystallized, in addition to being softened, thereby allowing poor tire appearance derived from whitening to be reduced.

Examples of such a polyalkylene glycol carboxylic acid alkyl ester may include C₅H₁₁—COO—(C₂H₄O)₃—CH₃, C₇H₁₅—COO—(C₂H₄O)₃—CH₃, C₇H₁₅—COO—(C₂H₄O)₅—CH₃, C₇H₁₅—COO—(C₃H₆O)₃—CH₃, C₉H₁₉—COO—(C₂H₄O)₃—CH₃, C₁₁H₂₃—COO—(C₂H₄O)₃—CH₃, C₁₁H₂₃—COO—(C₂H₄O)₅—CH₃, C₁₁H₂₃—COO—(C₂H₄O)₇—CH₃, C₁₁H₂₃—COO—(C₃H₆O)₃—CH₃, C₁₁H₂₃—COO—(C₃H₆O)₅—CH₃, C₁₁H₂₃—COO—(C₂H₄O)₃—(C₃H₆O)₂—CH₃, C₁₁H₂₃—COO—(C₂H₄O)₃—C₂H₅, C₁₃H₂₇—COO—(C₂H₄O)₃—CH₃, C₁₅H₃₁—COO—(C₂H₄O)₃—CH₃, C₁₇H₃₃—COO—(C₂H₄O)₃—CH₃, C₁₇H₃₃—COO—(C₂H₄O)₅—CH₃, C₁₇H₃₃—COO—(C₂H₄O)₇—CH₃, C₁₈ derived fatty acid remnant-O—(C₂H₄O)₃—CH₃, C18 derived fatty acid remnant-O—(C₂H₄O)₅—CH₃, C₁₈ derived fatty acid remnant-O—(C₂H₄O)₇—CH₃, C₁₈ derived fatty acid remnant-O—(C₃H₆O)₃—CH₃, C₁₉H₃₉—COO—(C₂H₄O)₃—CH₃, etc. These may be one type or mixtures of two or more types. Moreover, the C₁₈ derived fatty acid portion is (R¹CO) and indicates a mixed fatty acid derived from plants and animals, the main components thereof having 18 carbons at this portion.

For the case in which a composition of polyalkylene glycol carboxylic acid alkyl ester is achieved as a hydrophobic coating agent, excellent stability and handleability can be obtained. In contrast, for the case in which a composition is achieved as a water based coating agent, components such as a solubilizing agent or an emulsifier can be blended in order to obtain a uniform formulation of polyalkylene glycol carboxylic acid alkyl ester and water, as long as they do not impair performance. Examples of such components include: anionic surfactants such as carboxylate, higher alcohol sulfate ester salt, alkyl benzene sulfonate, and dialkyl sulfosuccinate; nonionic surfactants such as alcohol ethoxylate; solvents such as ethylene glycol, propylene glycol, diethylene glycol, 2-ethylhexyl diglycol, hexyl diglycol, glycerin, phenoxy ethanol, and 1,3-butylene glycol; urea; sodium benzenesulfonate; sodium toluene sulfonate; sodium xylene-sulfonate; sodium cumenesulfonate; etc., with one type or a combination of two or more types thereof capable of being used.

The tire surface coating agent according to the present technology can contain any component as required as long as it does not disturb the effects. Exemplary components include a pH adjustor, a pH buffer, a chelating agent, a liquid stabilizer, an antiseptic, an antioxidant, an inorganic salt, a dispersant, an antifoaming agent, etc.

The content of the polyalkylene glycol carboxylic acid alkyl ester is from 2 to 100 wt. % and preferably from 3 to 70 wt. %, per 100 wt. % of the tire surface coating agent. In a case where the content of the polyalkylene glycol carboxylic acid alkyl ester is less than 2 wt. %, whitening and browning on the tire surface cannot be sufficiently suppressed.

While the preparation of the polyalkylene glycol carboxylic acid alkyl ester is not particularly limited, it can be manufactured by conventionally known methods in accordance with the intended purpose, for example, a method of ester exchange of oils and fats with polyalkylene glycol alkylether, a method for esterifying fatty acid with polyalkylene glycol alkylether, a method of ester exchange of fatty acid alkyl ester with polyalkylene glycol alkylether, a reaction method for directly inserting alkylene oxide in fatty acid alkyl ester, and can also be manufactured by combining the abovementioned manufacturing methods.

In the present technology, the abovementioned tire surface coating agent can be coated on the surface of an unvulcanized tire, then vulcanized and molded so as to manufacture a pneumatic tire. The pneumatic tire obtained by this manufacturing method can suppress wax, which has bloomed on the surface thereof, from being cured and whitening so as to obtain excellent tire appearance.

Examples of the tire surface coating agent to be coated on the surface of the unvulcanized tire may include a mold release agent, an outside tire paint, etc. For example, by including polyalkylene glycol carboxylic acid alkyl ester as a component of a water based mold release agent, when the water content evaporates during vulcanization, the polyalkylene glycol carboxylic acid alkyl ester serves as a thin film covering the tire surface, allowing whitening and browning of the tire appearance to be more effectively suppressed. As a water based mold release agent, any agent regularly used in unvulcanized tires may be used.

In the present technology, the tire surface coating agent exerts more effects upon use when it is coated on the surface of the pneumatic tire and product tire after vulcanization; alternatively, when a tire after coating is heated at 30 to 60° C. for 2 hours or longer. When a surface coating agent is coated on the surface of a tire and heated at 30 to 60° C. for 2 hours or longer, even if wax has already bloomed on the tire surface and curing has started, the surface coating agent is applied so as to soften the wax. Consequently, a more excellent effect of suppressing and reducing whitening on the tire surface can be obtained.

Examples of the tire surface coating agent to be coated on the surface of a vulcanized pneumatic tire may include a polishing wax, a polishing agent, tire coating, etc. For example, by including polyalkylene glycol carboxylic acid alkyl ester as the component of a water based polishing wax, when water content evaporates to dry the tire surface, the polyalkylene glycol carboxylic acid alkyl ester serves as a thin film so as to cover the tire surface, allowing whitening and browning of the tire appearance to be more effectively suppressed. As a water based polishing wax, any wax regularly used in pneumatic tires may be used.

Further, because commercially available water based polishing waxes are created by dispersing an organopolysiloxane, a silicone emulsion, a latex component, etc. in water using a surfactant, also when the polyalkylene glycol carboxylic acid alkyl ester is used for all or part of the surfactant components thereof, water based polishing waxes can be created which achieve the effect of preventing whitening.

The present technology is further described below by way of examples. However, the scope of the present technology is not limited to these examples.

### EXAMPLES

### Examples 1 to 9

Among tire rubber compositions having the compositions shown in Table 3, with the exception of the sulfur and the vulcanization accelerators, the components were kneaded in a 1.7 L sealed Banbury mixer for 5 minutes. The mixture was then extruded as a master batch and cooled at room temperature. The master batch was placed in the 1.7 L sealed Banbury mixer again and the sulfur and the vulcanization accelerators were then added to the master batch and mixed to prepare tire rubber composition 1. Obtained tire rubber composition 1 was used to create an unvulcanized rubber sheet having a thickness of 6 mm.

A tire surface coating agent having the blending proportion shown in Tables 1, 2 and including polyalkylene glycol carboxylic acid alkyl ester, sodium di-2-ethylhexyl sulfosuccinate (trade name “Lipal 870P” manufactured by Lion Corporation) as an anionic surfactant, and water was coated on this unvulcanized rubber sheet. Subsequently, the unvulcanized rubber sheet was vulcanized by compression molding in a predetermined mold at 170° C. for 10 minutes to manufacture a test piece. The whitening resistance, browning resistance, and ozone resistance of the obtained test piece were evaluated by the following methods.

### Whitening Resistance

The obtained test piece was left to stand at 40° C. for 2 weeks to adjust the state, after which the surface of the test piece was visually observed to evaluate the state of whitening based on the following determination criteria according to 5 levels. The obtained results are shown in the “Whitening resistance” rows of Tables 1, 2. Larger index values indicate superior whitening and less likely subjected to whitening.

5: No whitening is observed at all on the surface of the test piece.

4: Almost no whitening is observed on the surface of the test piece.

3: Whitening is not observed on the surface of the test piece.

2: Whitening is partially or slightly observed on the surface of the test piece.

1: Whitening is by and large observed on the surface of the test piece.

### Browning Resistance

After the obtained test piece was left to stand at 40° C. for 2 weeks to adjust the state, b* values (positive values are close to yellow) of yellow and blue shafts in CIE 1976 (L*, a*, b*) color space were obtained in accordance with JIS (Japanese Industrial Standard) Z8729 and the color tones (L*a*b*) on the surface of the test piece are shown in the “Browning resistance” rows of Tables 1, 2. Smaller index values of 3 or less indicate superior browning resistance.

### Ozone Resistance

A JIS No. 3 dumbbell test piece was cut out of the obtained test pieces in accordance with JIS K6251. This test piece was elongated by 20% and deteriorated at an ozone concentration of 50 pphm at 40° C. for 24 hours, after which the presence of cracks (ozone cracks) on the surface of the test piece was visually evaluated. The obtained results regarding the presence of ozone cracks are shown in the “Ozone deterioration” rows of Table 1.

TABLE 1

| | | Comparative | | | | | | |
|---|---|---|---|---|---|---|---|---|
| | | Example 1 | Example 1 | Example 2 | Example 3 | Example 4 | Example 5 | Example 6 |
| Water | wt. % | 100 | 66 | 66 | 66 | 66 | 66 | 66 |
| Anionic | wt. % | — | 4 | 4 | 4 | 4 | 4 | 4 |
| surfactant | | | | | | | | |
| Type of | — | None | Ester 1 | Ester 2 | Ester 3 | Ester 4 | Ester 5 | Ester 8 |
| compound | | | | | | | | |
| Added amount | wt. % | — | 30 | 30 | 30 | 30 | 30 | 30 |
| of compound | | | | | | | | |
| Whitening | ° C. | 1 | 3 | 5 | 5 | 3 | 4 | 3 |
| resistance | | | | | | | | |
| Browning | — | 5 | 3 | 2 | 2 | 3 | 3 | 3 |
| resistance | | | | | | | | |
| Ozone | — | None | None | None | None | None | None | None |
| deterioration | | | | | | | | |

TABLE 2

| | | | | | Comparative | Comparative | Comparative | Comparative |
|---|---|---|---|---|---|---|---|---|
| | | Example 7 | Example 8 | Example 9 | Example 2 | Example 3 | Example 4 | Example 5 |
| Water | wt. % | 86 | 0 | 26 | 98.9 | 97.1 | 66 | 66 |
| Anionic | wt. % | 4 | — | 4 | 1 | 1 | 4 | 4 |
| surfactant | | | | | | | | |
| Type of | — | Ester 1 | Ester 1 | Ester 4 | Ester 1 | Ester 1 | Ester 6 | Ester 7 |
| compound | | | | | | | | |
| Added | wt. % | 10 | 100 | 70 | 0.1 | 1.9 | 30 | 30 |
| amount of | | | | | | | | |
| compound | | | | | | | | |
| Whitening | ° C. | 3 | 4 | 4 | 1 | 2 | 2 | 3 |
| resistance | | | | | | | | |
| Browning | — | 3 | 3 | 3 | 4 | 3 | 4 | 4 |
| resistance | | | | | | | | |
| Ozone | — | None | None | None | None | None | None | None |
| deterioration | | | | | | | | |

Each of the polyalkylene glycol carboxylic acid alkyl esters used in Tables 1, 2 (Esters 1 to 8 described in Tables 1, 2), prepared by the following manufacturing method, was used.

C₅H₁₁—COO—(C₂H₄O)₃—CH₃ Ester 1:

A 5 L four neck flask was prepared with 1432 g of methyl caproate (manufactured by Junsei Chemical Co., Ltd.), 1724 g of triethylene glycol monomethylether (trade name “MTG” manufactured by Nippon Nyukazai Co., Ltd.), and 4.5 g of a tetraisopropoxy titanate (TPT) catalyst, then subjected to nitrogen substitution. Subsequently, while nitrogen was circulated at a flow rate of 1 mL/minute, the liquid temperature was increased to 140° C. to carry out an ester exchange reaction, after which methanol generated by the reaction was removed by distillation. After removing the methanol, the temperature was further increased to 160° C. while gradually decompressing to 1.0 kPa, to obtain a crude product (1A) having 3% or less unreacted methyl caproate and triethylene glycol monomethylether.

Subsequently, 30 g of Kyoword 500SH was added to 1500 g of the crude product (1A) and stirred for 1 hour while the liquid temperature was maintained at 100° C. to carry out adsorption treatment of the catalyst. Subsequently, 7.5 g of Hyflo Super-Cel was further added as a filter aid, stirred for 10 minutes so as to be uniformly dispersed, then pressure filtrated at 80° C. to obtain Ester 1.

C₁₁H₂₃—COO—(C₂H₄O)₃—CH₃ Ester 2:

Ester 2 was obtained in the same manner as Ester 1, except that the prepared amount of methyl laurate (trade name “Pastel M12” manufactured by Lion Corporation) instead of methyl caproate was 1714 g, the prepared amount of triethylene glycol monomethylether was 1313 g, the ester exchange reaction temperature was 190° C., and after removing the methanol, the temperature was increased to 200° C. while gradually decompressing to 1.0 kPa.

C₁₇H₃₃—COO—(C₂H₄O)₃—CH₃ Ester 3:

Ester 3 was obtained in the same manner as Ester 1, except that the prepared amount of methyl oleate (trade name “Pastel M182” manufactured by Lion Corporation) instead of methyl caproate was 2372 g, the prepared amount of triethylene glycol monomethylether was 1314 g, the ester exchange reaction temperature was 190° C., and after removing the methanol, the temperature was increased to 200° C. while gradually decompressing to 1.0 kPa.

C₁₁H₂₃—COO—(C₂H₄O)₇—CH₃ Ester 4:

Alumina-magnesia hydroxide (Kyoword 300SN manufactured by Kyowa Chemical Industry Co., Ltd.) having the chemical formula 2.5MgO.Al₂O₃.nH₂O was fired at 750° C. for 3 hours in a nitrogen stream to obtain a fired alumina-magnesium hydroxide (Al/Mg molar ratio=0.44/0.56) catalyst. A 4 L autoclave was prepared with 535.7 g of methyl laurate and 7.2 g of the obtained catalyst and subjected to nitrogen substitution. Subsequently, the temperature was increased to 180° C., the interior of the reactor was returned back to normal pressure with nitrogen, and 770 g of ethylene oxide (equivalent to 7 mols with regard to 1 mol of methyl laurate) was gradually introduced in the container. Immediately following completion of the introduction, the pressure, which had been 0.34 MPa, was decreased as the reaction progressed and the EO addition reaction was continued until the pressure was fixed at 0.29 MPa after 2 hours. 19.6 g of Hyflo Super-Cel (manufactured by Celite Corporation: diatomaceous earth) (1.5% with regard to a crude product 1B) was added to 1305 g of the obtained crude product 1B, uniformly dispersed, and then pressure filtrated at 80° C. to obtain Ester 4.

C₁₁H₂₃—COO—(C₃H₆O)₃—CH₃ Ester 5:

Ester 5 was obtained in the same manner as Ester 1, except that 1286 g of methyl laurate was prepared instead of methyl caproate, 1238 g of tripropylene glycol methylether (trade name “MFTG” manufactured by Nippon Nyukazai Co., Ltd.) was used instead of triethylene glycol monomethylether, the temperature was increased to 160° C. to carry out an ester exchange reaction, and after removing the methanol, the temperature was increased to 185° C. while gradually decompressing to 1.0 kPa.

C₁₁H₄₃—COO—(C₂H₄O)₃—CH₃ Ester 6:

Ester 6 was obtained in the same manner as Ester 1, except that the prepared amount of methyl behenate (manufactured by Tokyo Chemical Industry Co., Ltd.) instead of methyl caproate was 2127 g, the prepared amount of triethylene glycol monomethylether was 985 g, the ester exchange reaction temperature was 190° C., and after removing the methanol, the temperature was increased to 200° C. while gradually decompressing to 1.0 kPa.

C₁₁H₂₃—COO—(C₂H₄O)_{10.6}—CH₃ Ester 7:

Ester 7 was obtained in the same manner as Ester 1, except that 900 g of methyl laurate was prepared instead of methyl caproate, 2100 g of polyethylene glycol monomethylether (trade name “Pluriol A500E” manufactured by BASF) having an average molecular weight of 500 was used instead of triethylene glycol monomethylether, the temperature was increased to 170° C. to carry out an ester exchange reaction, and after removing the methanol, the temperature was increased to 185° C. while gradually decompressing to 1.0 kPa.

C₁₇H₃₃—COO—(C₂H₄O)₇—CH₃ Ester 8:

Ester 8 was obtained in the same manner as Ester 4, except that the prepared amount of methyl oleate instead of methyl laurate was 593 g, and the prepared amount of ethylene oxide was 616 g.

TABLE 3
Shared blending proportion of rubber compositions

| | |
|---|---|
| NR | 40 parts by weight |
| BR | 60 parts by weight |
| Carbon black | 50 parts by weight |
| Amine based anti-aging agent | 4.0 parts by weight |
| Paraffin wax | 2.0 parts by weight |
| Aromatic oil | 10.0 parts by weight |
| Zinc oxide | 3.0 parts by weight |
| Stearic acid | 1.5 parts by weight |
| Sulfur | 1.5 parts by weight |
| Vulcanization accelerator | 0.8 parts by weight |

Note that the types of raw materials used in Table 3 are described below.
NR: natural rubber, SIR-20
BR: Butadiene rubber; Nipol BR1220 manufactured by Zeon Corporation
Carbon black: Sho Black N550 manufactured by Cabot Japan K.K.
Amine based anti-aging agent: N-(1,3-dimethylbutyl)-N-phenyl-p-phenylenediamine, Ozonone 6C manufactured by Seiko Chemical Co., Ltd.
Paraffin wax: Paraffin wax having 20 to 50 carbons, Sunnoc N manufactured by Ouchi Shinko Chemical Industrial Co., Ltd.
Aroma oil: Extract No. 4S (manufactured by Showa Shell Sekiyu K.K.)
Zinc oxide: Zinc Oxide #3 manufactured by Seido Chemical Co., Ltd.
Stearic acid: Beads Stearic Acid YR manufactured by NOF Corp.
Sulfur: “Golden Flower” oil-treated sulfur powder manufactured by Tsurumi Chemical Industry, Co., Ltd.
Vulcanization accelerator: NOCCELER CZ-G manufactured by Ouchi Shinko Chemical Industrial Co., Ltd.

As is clear from Tables 1, 2, it is confirmed that the tire surface coating agents of Examples 1 to 9 have excellent whitening resistance and browning resistance while ensuring favorable ozone resistance.

As is clear from Table 2, in the tire surface coating agents of Comparative Examples 2 and 3, because the blending amount of Ester 1 (polyalkylene glycol carboxylic acid alkyl ester) is less than 2 wt. %, whitening resistance and browning resistance cannot be ameliorated.

In the rubber composition of Comparative Example 4, R′ of general formula (I) of blended Ester 6 has more than 19 carbons, while in the rubber composition of Comparative Example 5, n of general formula (I) of blended Ester 7 exceeds 8. Therefore, whitening resistance and browning resistance cannot be sufficiently ameliorated.

### Examples 10 to 12

Except for the tire surface coating agent being changed to a water based mold release agent or oil based mold release agent containing the polyalkylene glycol carboxylic acid alkyl ester described in Table 4, the water based mold release agent or oil based mold release agent was coated on an unvulcanized rubber sheet as in Example 1, then vulcanized by compression molding to manufacture a test piece. The polyalkylene glycol carboxylic acid alkyl esters (Esters 3, 4) used in Table 4 are identical to Esters 3, 4 described in Table 1. The whitening resistance, browning resistance, and ozone resistance of the obtained test piece were evaluated as in the abovementioned method, with the obtained results shown in Table 4. Note that the blending proportion of the used water based mold release agent and oil based mold release agent is shown in Table 5.

TABLE 4

| | | Comparative | Example | Example | Comparative | Example |
|---|---|---|---|---|---|---|
| | | Example 6 | 10 | 11 | Example 7 | 12 |
| Water based mold | wt. % | 100 | 70 | 70 | 0 | 0 |
| release agent | | | | | | |
| Oil based mold | wt. % | 0 | 0 | 0 | 100 | 70 |
| release agent | | | | | | |
| Type of compound | — | None | Ester 3 | Ester 4 | None | Ester 3 |
| Added amount of | wt. % | — | 30 | 30 | — | 30 |
| compound | | | | | | |
| Whitening | ° C. | 1 | 4 | 4 | 1 | 4 |
| resistance | | | | | | |
| Browning | — | 5 | 3 | 2 | 5 | 2 |
| resistance | | | | | | |
| Ozone | — | None | None | None | None | None |
| deterioration | | | | | | |

TABLE 5

| | | Water based | Oil based |
|---|---|---|---|
| | | mold | mold |
| | | release agent | release agent |
| SBR latex | parts by weight | 20 | — |
| SBR | parts by weight | — | 0.92 |
| Hydrophilic silica | parts by weight | 1 | — |
| RCF carbon black | parts by weight | — | 5 |
| 2-butoxy ethanol | parts by weight | 1 | — |
| Surfactant | parts by weight | 3 | — |
| Water | parts by weight | 75 | — |
| Zinc oxide | parts by weight | — | 0.05 |
| Sulfur | parts by weight | — | 0.02 |
| Vulcanization | parts by weight | — | 0.01 |
| accelerator | | | |
| Rubber volatile oil | parts by weight | — | 94 |

Note that the types of raw materials used in Table 5 are described below.
SBR latex: Nipol LX430 manufactured by Zeon Corporation
SBR: Nipol SBR1502 manufactured by Zeon Corporation
Hydrophilic silica: AEROSIL200 manufactured by DSL. Japan Co., Ltd.
RCF carbon black: SUNBLACK SB200 manufactured by Asahi Carbon Co., Ltd.
2-butoxy ethanol manufactured by Tokyo Chemical Industry Co., Ltd.
Surfactant: Leox CL-50 manufactured by Lion Corporation
Water: distilled water
Zinc oxide: Zinc Oxide #3 manufactured by Seido Chemical Co., Ltd.
Sulfur: “Golden Flower” oil-treated sulfur powder manufactured by Tsurumi Chemical Industry, Co., Ltd.
Vulcanization accelerator: NOCCELER CZ-G manufactured by Ouchi Shinko Chemical Industrial Co., Ltd.
Rubber volatile oil: LA rubber volatile oil (G) manufactured by JXTG Nippon Oil & Energy Corporation

As is clear from Table 4, it is confirmed that the tire surface coating agents (water based mold release agents and oil based mold release agents) of Examples 10 to 12 have excellent whitening resistance and browning resistance while ensuring favorable ozone resistance.

### Examples 13 to 21

The abovementioned obtained tire rubber composition 1 was used to create an unvulcanized rubber sheet having a thickness of 6 mm, which was vulcanized by compression molding in a predetermined mold at 170° C. for 10 minutes to manufacture a vulcanized rubber sheet, then left to stand at 40° C. for 2 weeks to adjust the state. A tire surface coating agent having the blending proportion shown in Tables 6, 7 and including polyalkylene glycol carboxylic acid alkyl ester and water was coated on the surface of a vulcanized rubber sheet in which the wax was bloomed and whitened, then heated at 40° C. for 3 hours and dried. These are test pieces of Examples 13 to 21 and Comparative Examples 8 to 12, wherein the whitening resistance, browning resistance, and ozone resistance thereof were evaluated as in the abovementioned method, with the obtained results shown in Tables 6, 7.

TABLE 6

| | | Comparative | Example | Example | Example | Example | Example | Example |
|---|---|---|---|---|---|---|---|---|
| | | Example 8 | 13 | 14 | 15 | 16 | 17 | 18 |
| Water | wt. % | 100 | 70 | 70 | 70 | 70 | 70 | 70 |
| Type of | — | None | Ester 1 | Ester 2 | Ester 3 | Ester 4 | Ester 5 | Ester 8 |
| compound | | | | | | | | |
| Added amount | wt. % | — | 30 | 30 | 30 | 30 | 30 | 30 |
| of compound | | | | | | | | |
| Whitening | ° C. | 1 | 4 | 4 | 4 | 4 | 4 | 3 |
| resistance | | | | | | | | |
| Browning | — | 5 | 2 | 2 | 2 | 3 | 2 | 3 |
| resistance | | | | | | | | |
| Ozone | — | None | None | None | None | None | None | None |
| deterioration | | | | | | | | |

TABLE 7

| | | Example | Example | Example | Comparative | Comparative | Comparative | Comparative |
|---|---|---|---|---|---|---|---|---|
| | | 19 | 20 | 21 | Example 9 | Example 10 | Example 11 | Example 12 |
| Water | wt. % | 95 | 0 | 30 | 99.9 | 98.1 | 70 | 70 |
| Type of | — | Ester 1 | Ester 1 | Ester 4 | Ester 1 | Ester 1 | Ester 6 | Ester 7 |
| compound | | | | | | | | |
| Added amount | wt. % | 5 | 100 | 70 | 0.1 | 1.9 | 30 | 30 |
| of compound | | | | | | | | |
| Whitening | ° C. | 3 | 3 | 4 | 1 | 1 | 1 | 1 |
| resistance | | | | | | | | |
| Browning | — | 3 | 3 | 3 | 5 | 5 | 5 | 4 |
| resistance | | | | | | | | |
| Ozone | — | None | None | None | None | None | None | None |
| deterioration | | | | | | | | |

The polyalkylene glycol carboxylic acid alkyl esters (Esters 1 to 8) used in Tables 6, 7 are identical to Esters 1 to 8 described in Tables 1, 2.

As is clear from Tables 6, 7, it is confirmed that the tire surface coating agents of Examples 13 to 21 have excellent whitening resistance and browning resistance while ensuring favorable ozone resistance.

As is clear from Table 7, in the tire surface coating agents of Comparative Examples 9 and 10, because the blending amount of Ester 1 (polyalkylene glycol carboxylic acid alkyl ester) is less than 2 wt. %, whitening resistance and browning resistance cannot be ameliorated.

In the rubber composition of Comparative Example 11, R¹ of general formula (I) of blended Ester 6 has more than 19 carbons, while in the rubber composition of Comparative Example 12, n of general formula (I) of blended Ester 7 exceeds 8. Therefore, whitening resistance and browning resistance cannot be sufficiently ameliorated.

### Examples 22, 23

Except for the tire surface coating agent being changed to a water based polishing wax containing the polyalkylene glycol carboxylic acid alkyl ester described in Table 8, a vulcanized rubber sheet was created as in Example 13 and a water based polishing wax was coated on the vulcanized rubber sheet, then heated at 40° C. for 3 hours and dried to manufacture a test piece. The polyalkylene glycol carboxylic acid alkyl esters (Esters 3, 4) used in Table 8 are identical to Esters 3, 4 described in Table 1. The whitening resistance, browning resistance, and ozone resistance of the obtained test piece were evaluated as in the abovementioned method, with the obtained results shown in Table 8. Note that the blending proportion of the used polishing wax is shown in Table 9.

TABLE 8

| | | Comparative | Example | Example |
|---|---|---|---|---|
| | | Example 13 | 22 | 23 |
| Water based polishing wax | wt. % | 100 | 95 | 95 |
| Type of compound | — | None | Ester 3 | Ester 4 |
| Added amount of compound | wt. % | — | 5 | 5 |
| Whitening resistance | ° C. | 1 | 5 | 5 |
| Browning resistance | — | 5 | 2 | 2 |
| Ozone deterioration | — | None | None | None |

TABLE 9

| | | Polishing wax |
|---|---|---|
| Dimethyl polysiloxane | parts by weight | 19 |
| SBR latex | parts by weight | 1 |
| Surfactant | parts by weight | 10 |
| Water | parts by weight | 70 |

Note that the types of raw materials used in Table 9 are described below.
Dimethyl polysiloxane: KF96-1000cs manufactured by Shin-Etsu Chemical Co., Ltd.
SBR latex: Nipol LX430 manufactured by Zeon Corporation
Surfactant: Leox CL-50 manufactured by Lion Corporation
Water: distilled water

As is clear from Table 8, it is confirmed that the tire surface coating agents (water based polishing waxes) of Examples 22, 23 have excellent whitening resistance and browning resistance while ensuring favorable ozone resistance.

1. A tire surface coating agent, coated on the surface of an unvulcanized tire or a vulcanized pneumatic tire and comprising 2 to 100 wt. % of polyalkylene glycol carboxylic acid alkyl ester represented by general formula (I): 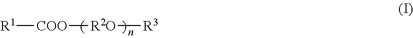
where R¹ represents a hydrocarbon group having 5 to 19 carbons, R² represents an ethylene group or a propylene group, R³ represents a methyl group or an ethyl group, and n is an integer of from 1 to 8.

2. The tire surface coating agent according to claim 1, wherein, in the general formula (I), R¹ represents a hydrocarbon group having 9 to 19 carbons, while n is an integer of from 1 to 5.

3. The tire surface coating agent according to claim 1, wherein, in the general formula (I), R¹ represents a hydrocarbon group having 9 to 19 carbons, R² represents an ethylene group, and n is an integer of from 1 to 5.

4. A method for manufacturing a pneumatic tire, wherein the tire surface coating agent according to claim 1 is coated on the surface of an unvulcanized tire, then vulcanized and molded.

5. Use of a tire surface coating agent, wherein the tire surface coating agent according to claim 1 is coated on the surface of a vulcanized pneumatic tire.

6. Use of a tire surface coating agent, wherein the tire surface coating agent according to claim 1 is coated on the surface of a vulcanized pneumatic tire, then heated at 30 to 60° C. for 2 hours or longer.

7. A method for manufacturing a pneumatic tire, wherein the tire surface coating agent according to claim 2 is coated on the surface of an unvulcanized tire, then vulcanized and molded.

8. Use of a tire surface coating agent, wherein the tire surface coating agent according to claim 2 is coated on the surface of a vulcanized pneumatic tire.

9. Use of a tire surface coating agent, wherein the tire surface coating agent according to claim 2 is coated on the surface of a vulcanized pneumatic tire, then heated at 30 to 60° C. for 2 hours or longer.

10. A method for manufacturing a pneumatic tire, wherein the tire surface coating agent according to claim 3 is coated on the surface of an unvulcanized tire, then vulcanized and molded.

11. Use of a tire surface coating agent, wherein the tire surface coating agent according to claim 3 is coated on the surface of a vulcanized pneumatic tire.

12. Use of a tire surface coating agent, wherein the tire surface coating agent according to claim 3 is coated on the surface of a vulcanized pneumatic tire, then heated at 30 to 60° C. for 2 hours or longer.
